(19) United States
(12) Patent Application Publication
(10) Pub. No.: US 2008/0297308 A1
(43) Pub. Date: Dec. 4, 2008

(54) System for Detection of an Interpersonal Communication Between Members of a Community and Relative Method

(76) Inventor: Mario Dino Di Floriano, Milano (IT)

Correspondence Address: YOUNG & THOMPSON, 209 Madison Street, Suite 500, ALEXANDRIA, VA, 22314, US

(21) Appl. No.: 11/659,077

(22) PCT Filed: Aug. 5, 2004
(86) PCT No.: PCT/IT2004/000443

§ 371 Date: May 2, 2007

(51) Int. Cl. H04Q 5/22

(52) U.S. Cl. 340/10.1

(57) ABSTRACT

A detection and interpersonal communication system includes a RFID tag storing a univocal code, which tag is remotely readable and embedded in a user's portable personal item, and a device reading the storing tag, the reading device including at least one RFID-reading antenna located in a significant area accessible by the user and capable of transmitting the acquired signals to a computer in a service centre, the computer storing a plurality of personal profiles of registered users, and a personal device for sending and receiving short messages to and from the service centre, which may be carried by each user, and profile association elements capable of finding a correlation between personal profiles of users who are detected in a significant area through the reading of their respective RFID tags, transmission elements of the service centre being able to send and receive short messages signalling the occurrence of certain correlation events.

### FIELD OF THE INVENTION

The present invention relates to a system and to a method for the detection of and the interpersonal communication between members of a community, in particular to a system of virtual communication which may be implemented through personal communication devices.

### BACKGROUND ART

As known, over recent times ever more efficient and fascinating interpersonal communication systems have been developed, which make use of modern technologies for voice and data transmission.

In particular, the development of the Internet and of similar communication networks, where data can be exchanged very quickly and potentially reaching a vast number of users, has allowed new methods of “virtual” communication with other people to become established. What determines the success of such systems, and the reason for their appeal, is that they make it possible to establish “virtual” relationships without directly exposing users and hence preserving their privacy. Such relationships may contribute to the development of acquaintances which serve as a linking element for the creation of potential communities or which represent the necessary prerequisite for possible subsequent “real” communication.

We have hence witnessed, for example, to the rise and evolution of online dating systems which, by addressing ever larger numbers of people, are an indication of actual social changes.

However, despite the large number of technological means available, such systems often do not meet the actual needs of users, since, for one reason or another, they strictly limit the creative communication potential and are above all a “cold” tool, unable to create random and varying conditions reflecting what happens in the real world.

For example, Internet-based systems are often a boring evolution of personal ads also found in the papers and, in addition to that, such service is perceived as directed at singles, and hence unsuitable for creating and nurturing a proper interpersonal exchange community.

Other unobtrusive interpersonal communication systems resort to electronic devices with processing and communication capabilities (for example PDAs or mobile phones equipped with proximity communication protocols, such as Bluetooth™). In this case, the personal electronic device (for example a mobile phone) constantly scans (through a suitable software) the surrounding area to identify similar personal electronic devices which are within the range of its communication system (for example a few metres in the case of Bluetooth™), with which to initiate data exchange—without the respective owners having a direct knowledge thereof. Data exchange may occur with the purpose of identifying specific preset personal profiles stored in other users' devices, or simply of exchanging personal data (such as e-mail addresses, for example) allowing subsequent “virtual” contact between the two owners.

However, by operating at close distance, these systems imply in any case a partial “real” reconnaissance of the user and may be unappealing to some users. Moreover, once a user has acquired the communication tool (for example the mobile phone with its own software), system functionality is completely up to the user's discretion and ability, which lessens the surprise factor at play (which is instead an important element to appreciate the system) and might hamper the growth and variability of the corresponding community. According to the approach adopted so far, that is inevitable, since no intervention by external subjects is provided, who may have an interest (at their advantage) in maintaining the whole system lively and appealing.

EP 1.224.637 discloses another interpersonal communication system which is capable of detecting other users' data at an even greater distance. However, operation thereof is univocally determined by one of the users, who decides to open a communication channel with another user, whose identity, on the other hand, cannot be kept fully undisclosed. Furthermore, such system does not allow to establish any relationship between the kind of communication and the specific area occupied by users. Finally, in this case too, system functionality cannot be controlled, not even partly, by a service centre, nor does it substantially provide the administrator with any financial gain, which means that it is not possible to introduce play variables or other parameters which make the whole system more lively.

The present invention originates in this context, in which the Applicant has identified room for the implementation of a new technology, which allows to overcome many of the limitations of the technologies so far on offer. In particular, the Applicant has undertaken to offer a new system for socialisation and interpersonal communication, fundamentally related to mobility and to mobile phone technology (which carries with itself a load of emotional values as the tool of choice for personal communication), which may be regarded as a tool of entry into a lively community, appealing due to elements of complicity, variableness and play and not directly and exclusively in view of personal encounters. The Applicant has further meant to provide a system, the functionality, variableness and appeal of which is not completely left to users' discretion, but where there may be an external party which monitors the operation thereof, with the aim both of possibly introducing stimulating variables and of suitably guiding the evolution of said system, and of creating value-added services which are a source of income.

Finally, it is an object of the Applicant to be able to offer a tool which can correlate the type of communication to the specific area occupied by users.

Such object is achieved through a system and a method as described in their essential features in the attached main claims.

Other inventive aspects of the system are described in the subsidiary claims.

Further features and advantages of the system and of the method according to the invention will in any case be clearer from the following detailed description of a preferred embodiment of the same, given by way of example and illustrated in the accompanying drawings, wherein:

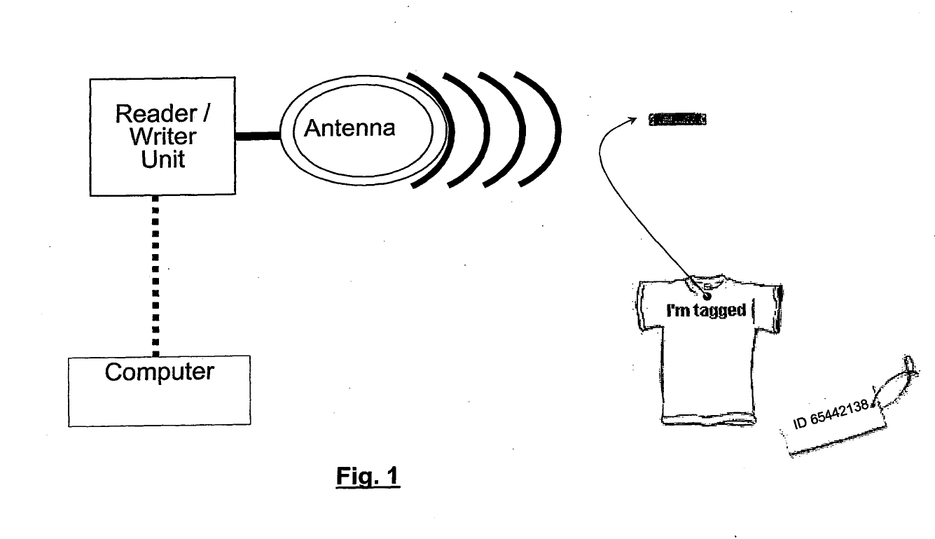

FIG. 1 is a diagram of an exemplary system for the reading of RFID tags according to the invention; and

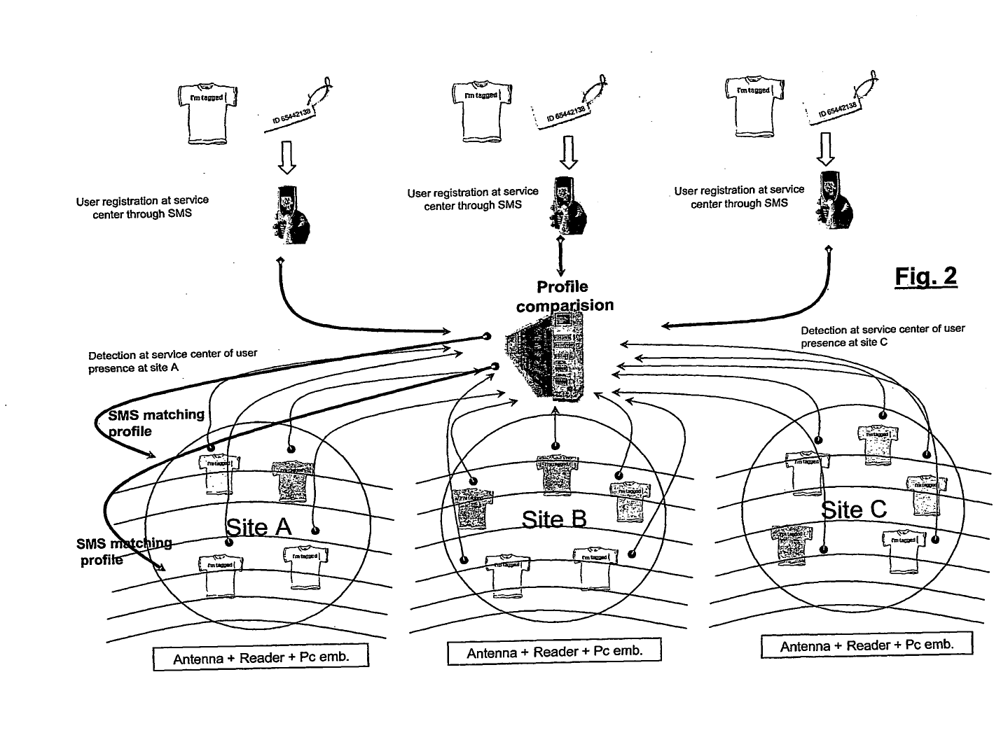

FIG. 2 is a diagram of communication initiated in the system of the invention.

### DESCRIPTION OF A PREFERRED EMBODIMENT

The communication system of the invention consists of a mobile component, personal to each user, and of a fixed component, managed by a service centre.

The personal component consists of a mobile phone and of a remotely-readable identification unit embedded in a garment, or other portable object (key-holder, card, etc.). According to the invention, this last unit consists of a univocal-code RFID tag, preferably an RFID which operates within the UHF band (typically at 869-915 MHz).

Within such context, the concept and operation of RFID tags will not be further dealt with, since they are devices known to an expert in the field. In order to better understand their operation, reference can be made, for example, to European patent application no. 03425648.7, filed in the name of the same Applicant.

For the purposes of the invention, the univocal code of the RFID tag, not being easily readable by the user, is also repeated, possibly in an abbreviated or simpler form, onto another support which may be read with the naked eye and paired, at least initially, with the garment (for example on the label shown in the attached drawing).

The fixed component of the system consists of an assembly of RFID-reading antennas, linked to a service centre which is in turn connected to a mobile phone network.

An exemplary diagram of a reading antenna is shown in FIG. 1. The antenna is connected to a reading/writing unit interfaced with a computer capable of managing the signal and of sending it, through a communication network, to the service centre.

RFID antennas are suitably located in a series of sites A, B, and C (for example in certain discotheques) or other enclosed areas capable of accommodating a plurality of people during special events (for example in an arena, in a cinema, in a conference room, etc.) or while shopping (in store chains) or while performing other tasks (in communities, hotels, airports, etc.). The antennas located in a same context (for example in a discotheque) can be connected to each other within a communication infrastructure (Internet LAN or ADSL) capable of ensuring communication to the service centre.

Advantageously, the areas covered by this service are suitably identified, for example through visual messages indicating service cover or their belonging to a specific community.

In the service centre a central computer is further implemented, in communication with the RFID-reading antennas and capable of sending and receiving SMS messages to and from mobile phones of authorised users. In the central computer a series of users' profiles are stored: in correspondence of each profile the univocal code of one's RFID tag is saved, as well as the telephone number of the mobile phone to which SMS messages are to be sent, and personal data (such as physical features, preferences, habits, etc.).

According to a preferred system embodiment, the personal profile database can be modified and updated by users themselves, who can send and change the data concerning their own personal profile both through SMS messages, and by accessing a specific Internet portal, where they are to previously log in.

From an operational point of view, the system of the invention works in the following manner.

A user purchases, or receives as a free gift during a promotion, a garment or other portable support, in which the RFID tag with univocal code is embedded, also provided with the readable label bearing the simplified code. The garment, as shown in the attached drawing, possibly carries a logo or other distinctive mark (I'm tagged!) which makes said garment identifiable as belonging to the virtual community established and governed by the system of the invention. If the user instead does not like to make himself identifiable, he or she can in any case choose other garments or personal supports provided with RFID tags and not visibly marked.

Entry in the community occurs through initial registration (FIG. 2): for that purpose the user sends an SMS message to the service centre, wherein the simplified code visible on the label, an own basic profile (according to a codification or mode described in a suitable leaflet associated with the garment), and possibly a further password code are entered. Successful registration is confirmed by the service centre through a return message, in which a password for subsequent access to the user's own profile is also provided. The user can later access his or her profile through an Internet portal or a suitable program loaded on his or her mobile phone to add and/or modify his or her personal data stored at the service centre.

When the user equipped with an RFID tag enters an area covered by the system of the invention, his presence is detected by the reading antennas and notified to the service centre.

The service centre can thereby automatically identify the profiles of all users who are detected in a common area and compare their respective stored profiles: in case “compatible” profiles are identified (according to criteria established by the users themselves or by the service centre, and which can be modified over time), the service centre provides to send an SMS message to the people in question, communicating such event.

At this point, alerted users can send an SMS message back to the service centre, to communicate what their availability is: for example, whether they would like to be in mutual contact (again through SMS messages to ensure anonymity), or to recognise each other in person by their clothes or to meet at an arranged point of the monitored area or place of entertainment, or again to swap e-mail addresses to continue communicating in a virtual manner, and so on.

According to an alternative embodiment of the system of the invention, communication can occur, as well as between users, also between users and the administrator of the service or of the community, or the manager of the place of entertainment where users are. This allows to obtain countless other functions and/or different forms of communication.

For example, the community administrator can intervene, if desired, in the complex network of relationship communications, by entering unforeseen variables, piloting communication direction according to suitable criteria, adding elements or keys during a game, and so on.

Another application of the system thus configured, provides that the manager of the place of entertainment or of the controlled area (discotheque, store, arena, etc.), depending on the profile of the users detected within said area, can send targeted advertisements or useful notices of a miscellaneous nature (general notices, game clues, directional information, etc.).

As can be well understood, with the system according to the invention all the objects set forth in the preliminary remarks are fully achieved. A system for the detection and interpersonal communication between members of a community has in fact been provided working even at remarkable distances within enclosed areas (such as concert halls or arenas) which preserves people's anonymity—respecting their privacy—while allowing efficient and consistent communication exchange, based on the matching of personalised profiles and caused by users' simultaneous presence in specific areas.

Furthermore, with the system according to the invention, interpersonal communication can occur for a series of different purposes, among which the establishment of “virtual” or “real” personal relationships, the taking part in conversations or games within a community, the transmission of targeted advertisements, and so on.

Finally, since the system provides the presence of a service centre which can make a profit out of the liveliness of the system (mainly in terms of SMS-message traffic and as a return on advertisements), there exists a concrete interest in the development and growth of communication through said system, which guarantees its lasting, efficiency and appeal to users.

It is understood, however, that the invention is not limited to the specific embodiments illustrated above, which merely represent non-limiting examples of the scope of the invention, but that a number of changes may be made, all within the reach of an expert in the field, without departing from the scope of the invention.

For example, despite reference has been made to a mobile phone as a unit of the portable component, similar operation can be obtained through any other portable personal communication tool, such as a PDA or other.

1-11. (canceled)

12. System for detection and interpersonal communication of the type comprising a tag storing a univocal code, remotely readable and embedded in a user's portable personal item, and a device reading said storing tag, characterised in that
said remotely-readable storing tag is an RFID tag,
said reading device comprises at least one RFID-reading antenna located in a significant area, which is accessible by the user, and capable of transmitting the acquired signals to a computer located at a service centre, said computer storing a plurality of personal profiles of registered users, and in that it further comprises
a personal device, for sending and receiving short messages to and from said service centre, portable by each user,
profile association means, residing in said service centre, capable of finding a correlation between personal profiles of users that are detected in a significant area through reading of their respective RFID tags, and
transmission means located in said service centre to send and receive, to and from personal devices belonging to users whose profiles are correlated, short messages signalling such correlation.

13. System as claimed in claim 12, wherein said portable personal item is provided with a support onto which said univocal code is written, or a simplified version thereof readable in a traditional manner by the user, said code being capable of registering with the service centre the functionality of said RFID tag associated with the data of said personal profile of the corresponding user.

14. System as claimed in claim 13, wherein interface means are provided, implemented in said service centre, through which each user can log in and change his or her personal profile associated with the registration of their own RFID tag.

15. System as claimed in 12, wherein said portable personal item is a garment and said support is a label.

16. System as claimed in 12, wherein said reading device comprises a plurality of reading antennas located in the points of access/exit of said area accessible by the user.

17. System as claimed in 12, wherein said short messages are in SMS-message format and are transmitted over a mobile phone network.

18. System as claimed in 12, wherein said RFID tag operates within the UHF frequency band.

19. Method for interpersonal communication employing a system as claimed in claim 12, wherein the following steps are provided
each user is provided with a portable personal item, wherein a remotely-readable storing tag with a univocal code is embedded, and with a personal device for sending and receiving short messages to and from a service centre,
characterised in that,
each univocal code of the storing tag is previously registered by the corresponding user into a database of said service centre associated with his own personal profile,
the presence of said storing tag in a significant area is detected by devices reading the storing tags located in significant areas accessible by users,
a signal corresponding to said presence in said significant area is transmitted to the service centre, where association means create a correlation depending on preset criteria and based on the users' personal profiles and on their presence in said significant area,
a short message signalling the occurrence of said correlations is sent by the service centre to said personal sending-receiving device of the user for which the correlation has occurred.

20. Method as claimed in claim 19, wherein said short message sent contains promotional messages.

21. Method as claimed in claim 19, wherein said correlation occurs between personal profiles of multiple users being present in said significant area at the same time, the personal profiles of whom may be associated according to said preset criteria.

22. Interpersonal communication and detection system of the type comprising at least one mobile component, consisting of a tag storing a univocal code, which tag is remotely readable and embedded in a user's portable personal item, and a personal communication device, characterised in that
said remotely-readable storing tag is an RFID tag,
and in that it further comprises a fixed component implying
at least one RFID-reading antenna located in a significant area accessible by the user and capable of transmitting the acquired signals to a computer in a service centre, said computer storing a plurality of personal profiles of registered users,
profile association means, residing in said service centre, capable of finding a correlation between personal profiles of users who are detected in a significant area through the reading of their respective RFID tags, and
transmission means located in the service centre to send and receive, to and from said personal communication devices of users whose profiles are correlated, short messages signalling the occurrence of such correlation.
